(19) United States
(12) Patent Application Publication
(10) Pub. No.: US 2025/0078536 A1
(43) Pub. Date: Mar. 6, 2025

(54) RETRIEVING LOST ITEMS IN THE VEHICLE

(71) Applicant: FCA US LLC, Auburn Hills, MI (US)

(72) Inventors: Sateesh Babu Palla, Hyderabad (IN); Anton Kneib, Rüsselsheim (DE)

(21) Appl. No.: 18/459,477

(22) Filed: Sep. 1, 2023

(51) Int. Cl. G06V 20/59; G06T 7/20; G06T 7/70; G06V 40/10

(52) U.S. Cl. CPC G06V 20/59; G06T 7/20; G06T 7/70; G06V 40/10; G06T 2207/10016; G06T 2207/30268

(57) ABSTRACT

A system and method of identifying objects within a vehicle determines a presence of an object from one or more images from one or more cameras having a field of view that includes at least a portion of an interior of a vehicle, determines a type of the object or determines at least one attribute of the object and records the presence of the object and one or both of the type of the object and the at least one attribute of the object. The recorded information can be conveyed to a user or used to provide an alert or reminder to a user, to enable a user to determine that one or more objects are in a vehicle.

### FIELD

The invention relates to systems and methods for determining the presence of objects in a vehicle with image data obtained from one or more cameras in the vehicle.

### BACKGROUND

Smaller items from everyday life can easily be forgotten in homes, public facilities, public transport or in a passenger car. The search for the lost items is often tedious, as the possible location of the respective lost item is no longer known. Such items are typically a laptop, an umbrella, a briefcase, folders, smartphones, clothing, suitcases, headgear, and the like. One possible location of a lost item is an interior of a vehicle.

### SUMMARY

A first aspect of the disclosure relates to a system for retrieving lost objects, in particular in an interior of a vehicle, comprising a user's terminal device, a camera unit used to capture the interior of the vehicle with its detection range, a computing unit connected to the camera unit and a communication unit connected to the computing unit, wherein the terminal equipment is designed to: to generate a request regarding a specific object on the basis of information provided by the user about the specific object, and wherein the computing unit is designed to automatically evaluate a camera image of the interior of the vehicle via the communication unit when receiving the request from the terminal device regarding the specific object and to check it for the presence of the requested object by means of image analysis and to send feedback to the terminal device to determine whether the specific object has been detected in the interior of the vehicle by means of the camera unit.

The user's device is preferably a tablet or a smartphone, but home user computers and similar electronic systems can also serve as end devices. Preferably, however, the user's terminal device is already equipped with an appropriate communication module for an Internet connection, especially for mobile Internet via 3G, 4G, 5G, etc.; If, in particular, a tablet or smartphone is used, this offers the advantage of a typically intended Internet connection and a touch-sensitive screen, so that a connection to the communication unit can be easily established, in particular by means of an easy-to-install application on the tablet or smartphone, which is intended in particular to be located in or on the vehicle.

In particular, the vehicle is a passenger car for 2-8 people and has a camera unit for capturing the interior. Therefore, the camera unit can also be called an indoor camera unit. Advantageously, the camera unit covers exactly those areas of the interior of the vehicle where objects are typically placed, such as the front seats, the rear area of the vehicle, or a luggage area of the vehicle.

With the help of the components of the system, it is therefore possible for the user to make a specification for the lost item on his end device, the terminal transmits corresponding information to the communication units connected to the computing unit, so that the computing unit uses the images (possibly also a single image) of the interior of the vehicle to create an automatic performs image analysis and can check the presence of the object in the interior of the vehicle. Corresponding feedback is transmitted back from the computing unit to the user's terminal device via the communication unit, so that the user is advantageously informed whether the lost item he is looking for may be in the interior of the vehicle.

It is therefore an advantageous effect of the at least some implementations that the user, who is looking for a lost object, receives help extremely quickly as to whether the lost object can be in the interior of the vehicle. It is therefore not necessary for the user to physically go to the vehicle itself and personally search the interior of the vehicle.

According to an advantageous embodiment, the computing unit is designed to control the communication unit and the camera unit for transmitting one or more images from the interior of the vehicle to the user's terminal equipment when receiving the request for the specific object, and to augment the respective image of the interior of the vehicle when the requested object is detected in the interior of the vehicle, that the requested object is marked separately in the interior of the vehicle in the respective picture.

With the help of this embodiment, the user not only receives information as to whether the object sought has been detected by the computing unit by image analysis in the interior of the vehicle, but the user can also carry out a check himself by viewing a single image of the interior or a video data stream of the interior, whereby the image or video advantageously depicts the area of the interior, on which the object was detected by the computing unit when it was detected. If the result is negative, i.e. the object searched for was not detected by the computing unit in the image analysis, the user can still view an image of the interior in order to check the result of the computing unit. According to another advantageous embodiment, the computing unit is designed to control the communication unit and the camera unit for transmitting images from the interior of the vehicle in the form of a video data stream for the user's terminal equipment when receiving the request for the specific object, wherein the terminal is designed to use a signal from the terminal equipment via the communication unit to control the camera unit for panning and/or zoom.

When a video data stream is transmitted, this embodiment results in a highly ergonomic way for the user to view the interior of the vehicle. By remotely controlling the camera unit over different areas of the interior and/or via different zoom levels, it is advantageously easy for the user to search the interior remotely using the camera unit itself.

According to another advantageous embodiment, the camera unit is designed to receive and process light in the infrared range.

Since the components of the vehicle and the objects remaining in the interior of the vehicle will always have a non-zero temperature, they emit infrared radiation, which can be detected by the camera unit. This makes it advantageous for the user to view the interior of the vehicle via image or video data stream even in the dark.

According to another advantageous embodiment, the terminal is designed to create a definition of the specific object from an input of the user in text form on the terminal for the request to the computing unit.

In the case of input in text form, the object is named in the form of a word or a combination of words, and the user's terminal device or the computing unit determines corresponding information from this, which is comparable to the information from the image analysis for the image or images of the camera unit in the interior of the vehicle.

According to another advantageous embodiment, the terminal device is designed to capture information about the specific object for the request to the computing unit by capturing a drawing input from the user and to create a definition of the concrete object from the captured drawing.

A drawing input is advantageously executed on a touch-sensitive screen of the end device. In this case, the outline of the object can be sketched by the user and the outlines of the interior of the vehicle can also be extracted in the image analysis of the computing unit, so that the outlines can be compared with each other, especially through similarity analysis.

According to another advantageous embodiment, the terminal device is designed to create a definition of the specific object from a selection of the user of a particular object from a list of predefined objects for the request to the computing unit.

In the list of predefined objects, corresponding features, contours, silhouettes, etc. are advantageous. of the respective objects, so that the stored data simplifies the comparison with the result of the image analysis.

According to another advantageous embodiment, the terminal device is designed to create a definition of the concrete object from an older photographic representation of the concrete object or a photographic representation of the same object for the request to the computing unit.

Another aspect of the disclosure relates to a method for retrieving lost objects, comprising the steps:
providing information about a lost item on a user's terminal device,
transmitting a request from the terminal regarding the specific item to a communication unit connected to a computing unit,
control of a camera unit by the computing unit to receive an image of the interior of the vehicle from the camera unit,
machine evaluation of the camera image of the interior of the vehicle by image analysis and checking the camera image for the presence of the requested object in the interior of the vehicle in each case by the computing unit, and
Sending feedback via the communication unit to the end device by the computing unit as to whether the specific object in the interior of the vehicle has been detected by means of the camera unit.

According to another advantageous embodiment, when receiving the request for the specific object, the communication unit and the camera unit are controlled to transmit one or more images from the interior of the vehicle for the user's terminal device, and if the requested object is detected in the interior of the vehicle, the respective image of the interior is augmented in such a way that the requested object is displayed in the interior of the vehicle in the is marked separately for each image.

According to another advantageous embodiment, a definition of the specific object is created on the terminal device for the request to the computing unit from an input in text form on the terminal device.

According to another advantageous embodiment, information about the specific object is recorded on the terminal device for the request to the computing unit by capturing a drawing input from the user and a definition of the concrete object is created from the recorded drawing.

According to another advantageous embodiment, a definition

of the specific object is created on the terminal device for the request to the computing unit by means of a selection of the user of a particular object from a list of predefined objects.

According to another advantageous embodiment, a definition of the concrete object is created on the terminal device for the request to the computing unit from an older photographic representation of the concrete object or a photographic representation of the same object.

Advantages and preferential training of the proposed method result from an analogous and analogous transfer of the explanations made above in connection with the proposed system.

In at least some implementations, a method of identifying objects within a vehicle, comprising:
determining a presence of an object from one or more images from one or more cameras having a field of view that includes at least a portion of an interior of a vehicle;
determining a type of the object or determining at least one attribute of the object; and
recording the presence of the object and one or both of the type of the object and the at least one attribute of the object.

In at least some implementations, the method also includes transmitting information relating to the presence of the object and one or both of the type of the object and the at least one attribute of the object. In at least some implementations, the information transmitted includes text indicating the presence and type of the object. In at least some implementations, the information transmitted includes one or more images from the one or more cameras that show an area of an interior of the vehicle in which the object is located. In at least some implementations, the information includes one or more of the size, shape, color and location of the object. In at least some implementations, the information transmitted includes a present image or video feed from one or more of the one or more cameras. In at least some implementations, the information transmitted includes a preselected image that is representative of the object.

In at least some implementations, the step of determining the presence of the object is accomplished with image recognition algorithms in a computing unit that associate an object within a field of view of the one or more cameras with a predetermined object type. In at least some implementations, the association is accomplished based upon one or more of the size, shape and color of the object.

In at least some implementations, the method also includes determining a movement of the object from a first location to a second location and recording the presence of the object at the second location. In at least some implementations, the information transmitted includes the second location.

In at least some implementations, the method includes establishing an identity of a person in the vehicle and associating the object with the person when the object is determined to be moved by the person.

In at least some implementations, the method also includes determining removal of the object from the vehicle and recording that the object is not present within the vehicle. In at least some implementations, the step of recording that the object is not present within the vehicle is accomplished by deleting the object from a list of objects recorded as being present in the vehicle.

In at least some implementations, the transmitting step is accomplished by a communication unit of the vehicle and via a wireless transmission protocol. In at least some implementations, the transmitting step is accomplished by providing a signal within the vehicle to alert a vehicle occupant to the presence of the object in the vehicle.

In at least some implementations, the method includes assigning a priority level to objects determined to be within the vehicle based upon a predetermined prioritization, and providing the signal when an object above a threshold priority level is determined to be within the vehicle and when it is determined that an occupant of the vehicle is likely to leave the vehicle. In at least some implementations, the determination that an occupant is likely to leave the vehicle is based upon detecting an opening of a door of the vehicle, turning off an engine or motor of the vehicle, detecting that a vehicle operating mode is changed to a park mode, or a combination of two or more of these events.

In at least some implementations, a vehicle camera image processing system, includes at least one processor and memory accessible by the at least one processor. The memory stores computer instructions that, when executed by the at least one processor, cause the image processing system to, receive image data captured by a vehicle camera, determine a type of the object, and record in the memory the presence in the vehicle of the object and the type of the object.

In at least some implementations, the system also includes a communication unit by which information about an object is wirelessly transmitted to a receiver located remotely from the vehicle.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a system for retrieving lost objects;

FIGS. 2A and 2B is a diagrammatic view of a user input to the lost item and the result of an image analysis in comparison;

FIG. 3 is a flowchart for a method for recovering lost objects; and

FIG. 4 is a flowchart for a method for determining presence of an object in a vehicle.

### DETAILED DESCRIPTION

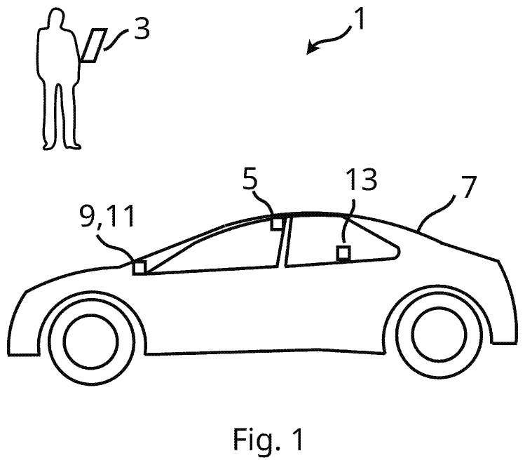

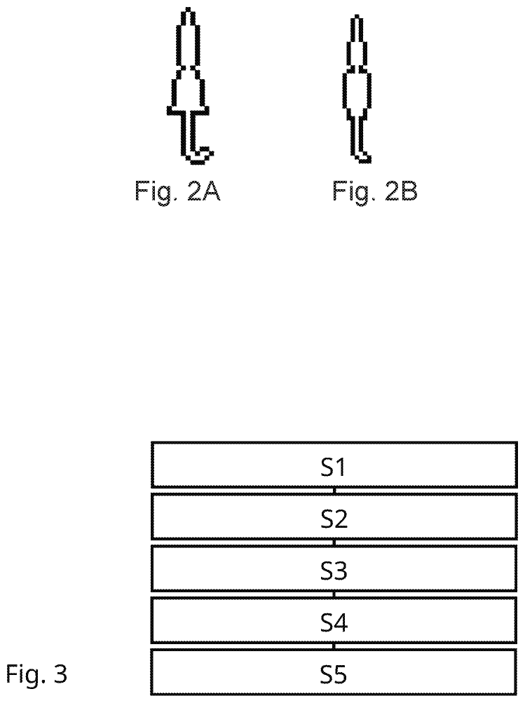

The depictions in the figures are schematic and not to scale. FIG. 1 shows a system 1 for retrieving lost items. Part of System 1 is a smartphone of the user in the function of a terminal device 3 of the user. Furthermore, the system includes a camera unit 5 in the interior of vehicle 7 with the ability to cover the interior of vehicle 7 even in the dark by detecting infrared radiation. Connected to the camera unit 5 is a computing unit 9 in vehicle 7, which has a communication unit 11 with Internet access. On terminal 3, the user selects an application that is set up to connect to the communication unit 11 of vehicle 7, selects the “Search for lost item” option, and draws a contour of the lost item 13 in the input window that opens. In FIG. 2A, as an example, the contour of an umbrella has been drawn by the user. The terminal device 3 transmits information about this contour to the communication unit 11 of the computing unit 9, which compares all objects detected by the interior of vehicle 7 and their contours with the contour transmitted by terminal 3 by means of similarity analysis. Further details can be found in FIG. 2 given. Via the communication unit 11, a feedback is sent to the terminal device 3 as to whether the specific object 13 has been detected in the interior of vehicle 7 by means of the camera unit 5.

FIG. 2A shows the contour of a drawn umbrella of the user. In addition, the computing unit 9 analyzes all objects in the interior of vehicle 7 and generates corresponding contours of these objects, as shown in FIG. 2B. By means of similarity analysis, the respective contours and other features of the objects are compared and thus, when a certain limit probability of the presence of object 13 within vehicle 7 is reached, a corresponding message is prepared for the user by sufficient similarity. For this purpose, the respective camera image of the camera unit 5 is automatically evaluated and checked by image analysis for the presence of the requested object 13.

FIG. 3 shows a method for retrieving lost items, comprising the steps:
Specifying S1 of information about a lost item 13 on a user's terminal equipment 3,
transmitting S2 of a request from terminal 3 regarding the specific item 13 to a communication unit 11 connected to a computing unit 9 which may include one or more processors and memory 10, or a control system,
Control S3 of a camera unit 5 by the computing unit 9 to receive an image of the interior of the vehicle 7 from the camera unit 5,
machine evaluation S4 of the camera image of the interior of the vehicle 7 by image analysis and checking the camera image for the presence of the requested object 13 in the interior of the vehicle 7 in each case by the computing unit 9, and
Sending feedback S5 via the communication unit 11 to the terminal device 3 by the computing unit 9 as to whether the specific object 13 has been detected in the interior of vehicle 7 by means of the camera unit 5, whereby a live camera image of the camera unit 5 is also transmitted to the user's terminal device 3 and, if the user is controlled accordingly, the camera unit 5 is set to infrared mode, to get sufficiently high-quality images in the dark.

In at least some implementations, the system is arranged to automatically recognize and categorize at least some objects 13 within the field of view of one or more cameras within an interior of the vehicle 7. The automatic recognition is accomplished by image analysis techniques or methods performed by the computing unit 9 on image data from the camera(s) 5, and the categorizing is performed by the computing unit 9 based upon the results or output of the recognition phase. The categories or types of objects may be predetermined and stored in memory 10 accessed by the computing unit, or otherwise available to the computing unit.

In at least some implementations, the computing unit 9 may be arranged to recognize from image data various objects that are known or predetermined to be or are commonly within vehicles. These objects include, by way of non-limiting category examples, mugs, cups, purses, wallets, mobile phones, tablets, computers, computer cases, briefcases, suitcases, umbrellas, sunglasses or other glasses, clothing like hats or jackets, keys and key fobs, and the like.

In at least some implementations, the computing unit may learn new objects that are within a certain vehicle on more than one occasion, and add the new object to a list or other data field of objects to track based on a frequency of appearance of the object within the vehicle. A user of the system or occupant of the vehicle may also be able to update the system (e.g. data store in memory in the vehicle or remotely located (e.g. cloud storage)) to include a description, type, category and the like of the object for future reference by the system. In this way, the system can learn objects and be programmed to recognize additional objects beyond the preset categories and types of objects, for a customized solution more useful to a particular owner or occupant of the vehicle. An application interface on a user end device may provide prompts to a user when an object is detected and for which a category or type of the object is not known or certainty above a desired certainty threshold. In this instance, the application may display to the user an image from a vehicle camera that includes the object in question, or the application may make a best guess as to the category or type of the object, and ask the user to confirm or deny the guess as to the category or type of the object.

In at least some implementations, the system includes a predetermined ranking or priority of objects based upon potential importance to a user (e.g. occupant). For example, items of higher monetary value may be ranked higher in priority than items of lower monetary value, and items more likely to be used often by an occupant may be ranked higher in priority than less used items. By way of examples, a mobile phone, wallet, purse or portable computer (e.g. laptop) may be ranked of higher importance or priority than a hat or beverage or other less valuable item. The predetermined ranking may be provided in the programming used by the computing unit, may be set or changed by a user to enable customization of the priority rankings by user/occupant, or both.

In at least some implementations, the computing unit may determine a last known or best guess/assumed location for objects detected to be in the vehicle and not removed from the vehicle. This may be determined by detecting movement of a recognized object and a location of the object after movement. For example, an occupant of one seat may place an object onto a vacant, adjacent seat. The system may detect the user moving the object to the adjacent seat, and then the object on the adjacent seat with the user's hand/arm moved away from the adjacent seat. The object may then be recorded as being on the seat, and each seat in the vehicle may have a unique identifier (e.g. driver's seat, front passenger seat, rear seat on driver's side, etc). Of course, other areas of the vehicle may be monitored, like cup holders, consoles, doors, glove box and cargo areas, and the seat/seats is just one example.

In at least some implementations, an object that is moved from a location within the field of view of one or more cameras to a location hidden from such field of view, such as within a glove box or console compartment, can be inventoried as being within such an area. These objects would not be viewable from a live feed from the one or more cameras. When an object is determined to be in a certain location within the vehicle, the system may record an image or video file of that location within the vehicle. The image or video file may show the object in that area or just the area, in the case of an object not within the field of view. As set forth above, one or more of the cameras may be responsive to infrared light to enable object detection and image recognition in low light conditions.

In at least some implementations, the output from the computing unit may be made available to a user via wireless communication of the computing unit with an end device. The end device may be a mobile phone, tablet, computer or the like. The wireless communication may be accomplished via any desired protocol or system, and may include direct communication between the end device and computing unit, such as by wifi or Bluetooth connection (by way of non-limiting examples) or indirect with information uploaded from the computing unit to a remote storage system (e.g. cloud data storage) for access by the end device.

The end device may include a suitable application program by which the user can review a list or an inventory of objects determined by the computing unit to be within the vehicle, as well as camera footage or images from the one or more cameras in the vehicle which show all or portions of the vehicle interior. The vehicle may include a display via which information about detected objects can be provided for viewing by a user. The inventory may include not only an identification of the object, but also a last known location of the object, and/or one or more attributes of the object, such as size, shape, color, brand name (e.g. if a logo or brand name is visible and detected by the system) and the date and time of the logged object detection/inventory event. The system may also be trained to recognize occupants of the vehicle, and objects may be associated with an occupant who brought the object into the vehicle, and the owner/possessor identity may be included in the inventory as an attribute of the object.

In at least some implementations, a user may revise the objects detected and reported as being within the vehicle to delete objects known to no longer be in the vehicle and to delete objects falsely determined to be in the vehicle (e.g. that were not actually in the vehicle as reported). Further, unknown objects may be categorized based upon one or more attributes like size, shape, color and location, for example. A user can provide an identification of an unknown object and the system may learn to identify that or a similar object in future interactions.

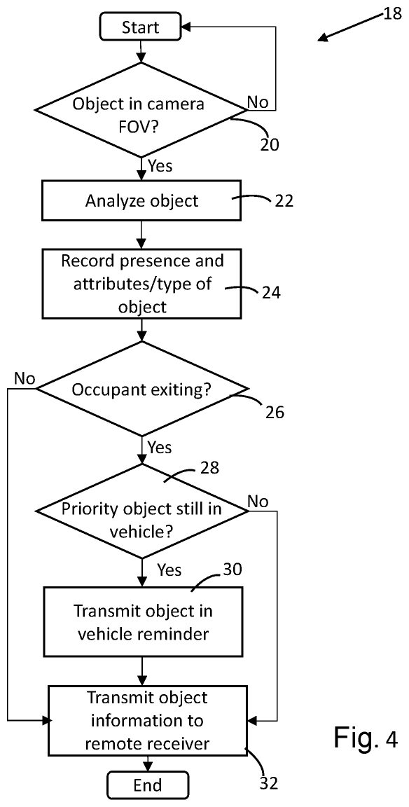

In the method 18 shown in FIG. 4, in step 20 when an object is detected within the vehicle, the system analyzes the object in step 22. If the analysis determines the object is of a known category or type, then the system records in step 24 that the object is present within the vehicle and the category or type of the object, such as mobile phone, sunglasses, purse, etc. The system may also record certain attributes of the object like size, shape, color, priority/ranking, and the location in the vehicle. The information may be recorded in memory included in the vehicle or transmitted wirelessly to a remote receiver such as a remote database or other memory device.

Next, the system may determine in step 26 that it is likely that an occupant is exiting the vehicle. As noted above, this may be done by detecting one or more changes in state of the vehicle or portions thereof (e.g. ignition off, motor/engine off, door opened, vehicle put into park gear/mode) or by detecting movement of an occupant that is consistent with the occupant beginning to exit the vehicle. If a vehicle occupant is exiting or is likely to exit the vehicle, then in step 28 the system may determine if an object above a threshold priority ranking is present within the vehicle, and if so, in step 30, a reminder may be issued. The reminder may be in any desired form, such as audible tone(s) or words, or visually displayed within the vehicle. The intent is to avoid a higher priority object being left behind in the vehicle after an occupant exits the vehicle.

In step 32, the system may periodically transmit information about an object that is detected to be within the vehicle. The information may be transmitted to a remote storage device as noted above, and/or to an end device of a user via an established application interface and connection with the vehicle or remote storage device (e.g. information or notices pushed to an end device like a phone, tablet or computer or requested by and transmitted to the end device).

An example of use of the system and methods described herein will be set forth in the next few paragraphs. In this example, a user sitting in driver's seat of the vehicle is identified as the vehicle-owner which identity/information may be pre-established, and recorded when confirmed by analyzing the image date from a vehicle camera. Next, the user removes from a pants pocket his mobile phone, and the system detects the hand movement of the user and then the object appearing in the image data for the first time as a mobile phone. The presence of the mobile phone in the vehicle is recorded, and may be associated with the user. When the user places the mobile phone on a center console of the vehicle, the system recognizes and records the new location.

Later, the user moves the mobile phone into a compartment of the vehicle for storage (or charging via a charge port). The system recognizes the movement of the mobile phone by a user in the direction of the compartment, and may recognize the mobile phone after being placed in the compartment and before a cover of the compartment is closed, or the system may recognize that the user's hand no longer holds the mobile phone and so placement of the mobile phone in a new location may be assumed. The system records the new location of the mobile phone if the location is known or determined with a desired threshold of certainty. If the new location of the mobile phone is not known with sufficient certainty, then the system may note the compartment or other location as a possible but not certain location.

After use of the car is terminated, the system may recognize the user grabbing and holding one or more objects, or storing one or more objects on the user or in a purse or bag held by the user. This indicates that the user is removing or will remove these objects from the vehicle. If such removal is confirmed by analysis of image data, then the system can delete those objects from a list of objects determined to still be within the vehicle, or the list/data can be updated to indicate that the object was removed, and if known, by whom. In at least some implementations, a further check of objects in the vehicle may be performed after the vehicle is put in park and the occupants have left the vehicle.

The system and method may thus determine not only the presence of an object in a vehicle but also information about the object. The system may record and store for review by a user certain attributes of the object such as the size, shape, color, brand, number of times the object has been detected in the vehicle, position in the vehicle, associated user who brought the object into the vehicle or who moved the object within the vehicle, and a ranking of priority or importance of the object. The system may provide a list of the items left in the vehicle after occupants have left the vehicle, where the fact that occupants have left the vehicle may be determined by computing unit analysis of image data from one or more vehicle cameras. The list of items may include text or images or both representing the objects left in the vehicles. The images may be preselected images representative of the objects, or images from a vehicle camera showing the actual object, or both.

The systems and methods set forth herein may facilitate determination by a user if one or more objects have been left in a vehicle. This can be a great convenience to the user when, for example, the user is not near the vehicle such that directly searching the vehicle is not practical or convenient. The system may record the presence of objects placed in the vehicle prior to driving the vehicle, may record the change in location of objects during use of the vehicle, and may alert a user to the presence of at least some objects after use of the vehicle to reduce instances of objects unintentionally behind left in the vehicle.

Although the invention has been illustrated and explained in more detail by preferred embodiments, the invention is not limited by the disclosed examples and other variations may be inferred from them by those skilled in the art without leaving the scope of the invention. It is therefore clear that a large number of variations exist. It is also clear that the embodiments given by way of example are really only examples which are not in any way to be understood as a limitation, for example, of the scope of protection, the possible applications or the configuration of the invention. Rather, the preceding description and the description of the figures enable the skilled person to concretely implement the exemplary embodiments, whereby the skilled person, knowing the disclosed idea of the invention, can make a variety of changes, for example with regard to the function or the arrangement of individual elements mentioned in an exemplary embodiment, without leaving the scope of protection imposed by the claims and their legal equivalents, such as further explanations in the description.

What is claimed is:

1. A method of identifying objects within a vehicle, comprising:
determining a presence of an object from one or more images from one or more cameras having a field of view that includes at least a portion of an interior of a vehicle;
determining a type of the object or determining at least one attribute of the object; and
recording the presence of the object and one or both of the type of the object and the at least one attribute of the object.

2. The method of claim 1 which also includes transmitting information relating to the presence of the object and one or both of the type of the object and the at least one attribute of the object.

3. The method of claim 2 wherein the information transmitted includes text indicating the presence and type of the object.

4. The method of claim 2 wherein the information transmitted includes one or more images from the one or more cameras that show an area of an interior of the vehicle in which the object is located.

5. The method of claim 1 wherein the step of determining the presence of the object is accomplished with image recognition algorithms in a computing unit that associate an object within a field of view of the one or more cameras with a predetermined object type.

6. The method of claim 5 wherein the association is accomplished based upon one or more of the size, shape and color of the object.

7. The method of claim 1 which also includes determining a movement of the object from a first location to a second location and recording the presence of the object at the second location.

8. The method of claim 7 wherein the information transmitted includes the second location.

9. The method of claim 2 wherein the information includes one or more of the size, shape, color and location of the object.

10. The method of claim 1 which includes establishing an identity of a person in the vehicle and associating the object with the person when the object is determined to be moved by the person.

11. The method of claim 2 wherein the information transmitted includes a present image or video feed from one or more of the one or more cameras.

12. The method of claim 2 wherein the information transmitted includes a stock image that is representative of the object.

13. The method of claim 1 which also includes determining removal of the object from the vehicle and recording that the object is not present within the vehicle.

14. The method of claim 13 wherein the step of recording that the object is not present within the vehicle is accomplished by deleting the object from a list of objects recorded as being present in the vehicle.

15. The method of claim 2 wherein the transmitting step is accomplished by a communication unit of the vehicle and via a wireless transmission protocol.

16. The method of claim 2 wherein the transmitting step is accomplished by providing a signal within the vehicle to alert a vehicle occupant to the presence of the object in the vehicle.

17. The method of claim 16 which includes assigning a priority level to objects determined to be within the vehicle based upon a predetermined prioritization, and providing the signal when an object above a threshold priority level is determined to be within the vehicle and when it is determined that an occupant of the vehicle is likely to leave the vehicle.

18. The method of claim 17 wherein the determination that an occupant is likely to leave the vehicle is based upon detecting an opening of a door of the vehicle, turning off an engine or motor of the vehicle, detecting that a vehicle operating mode is changed to a park mode, or a combination of two or more of these events.

19. A vehicle camera image processing system, comprising:
at least one processor; and
memory accessible by the at least one processor, the memory storing computer instructions that, when executed by the at least one processor, cause the image processing system to:
receive image data captured by a vehicle camera;
determine a type of the object; and
record in the memory the presence in the vehicle of the object and the type of the object.

20. The system of claim 19 which also includes a communication unit by which information about an object is wirelessly transmitted to a receiver located remotely from the vehicle.
